(19) United States
(12) Patent Application Publication
(10) Pub. No.: US 2020/0311692 A1
(43) Pub. Date: Oct. 1, 2020

(54) OFFICE COMPUTER AND PROGRAM

(71) Applicant: TOSHIBA TEC KABUSHIKI KAISHA, Tokyo (JP)

(72) Inventor: Keigo Shibata, Tagata Shizuoka (JP)

(21) Appl. No.: 16/720,268

(22) Filed: Dec. 19, 2019

(30) Foreign Application Priority Data
Mar. 26, 2019 (JP) 2019-057724

(51) Int. Cl. G06Q 10/10

(52) U.S. Cl. CPC G06Q 10/1097; G06F 9/4401

(57) ABSTRACT

An office computer according to an embodiment includes a storing section configured to store office work deadline information output from a plurality of job applications for executing various kinds of office work and a deadline alert section configured to acquire the office work deadline information from the storing section and output a reminder notification without executing each of the job applications.

### CROSS-REFERENCE TO RELATED APPLICATION

This application is based upon and claims the benefit of priority from Japanese Patent Application No. 2019-057724, filed in Mar. 26, 2019, the entire contents of which are incorporated herein by reference.

### FIELD

Embodiments described herein relate generally to an office computer and a program.

### BACKGROUND

An office computer is an information processing apparatus specialized for information processing and printing processing for bills and sales slips.

The office computer includes input and output devices such as a display, a keyboard, and a mouse and a printer capable of performing printing on copy slips. Among these devices, the display and the printer are configured integrally with a main body section.

The office computer executes various job applications. The job applications often have deadline management functions (reminder display functions). For example, in a program for issuing bills, a deadline management function operates on a designated day at the end of a month and displays a reminder on the display to call an operator's attention.

However, these deadline management functions do not operate unless the respective job applications are executed. Therefore, it is likely that, for example, the reminder is not displayed on the display on the designated day at the end of the month and the operator forgets to issue bills.

### DESCRIPTION OF THE DRAWINGS

FIG. 1 is an exterior perspective view of an office computer in an embodiment;

FIG. 2 is a functional block diagram illustrating a functional configuration of the office computer;

FIG. 3 is a software hierarchy chart of the office computer;

FIG. 4 is a flowchart illustrating a reminder processing process of the office computer;

FIG. 5A is a diagram illustrating a setting screen for a reminder notification;

FIG. 5B is a diagram illustrating the reminder notification; and

FIG. 5C is a diagram illustrating a home screen.

### DETAILED DESCRIPTION

An advantage of embodiments is to provide an office computer and a program that can output a reminder notification without executing a job application.

In general, an office computer according to an embodiment includes: a storing section configured to store office work deadline information output from a plurality of job applications for executing various kinds of office work; and a deadline alert section configured to acquire the office work deadline information from the storing section and output a reminder notification without executing each of the job applications.

In the office computer according to the embodiment, the deadline alert section may operate during a bootstrap started by power-on.

In the office computer according to the embodiment, the deadline alert section may be controlled by middleware for mediating the job application and an operation system.

In the office computer according to the embodiment, the deadline alert section may display the reminder notification prior to a home screen displayed after a start.

A method according to an embodiment includes: storing office work deadline information output from a plurality of job applications for executing various kinds of office work; and acquiring the office work deadline information and outputting a reminder notification without executing each of the job applications.

An office computer in an embodiment is explained with reference to the drawings. In the drawings, the same components are denoted by the same reference numerals and signs.

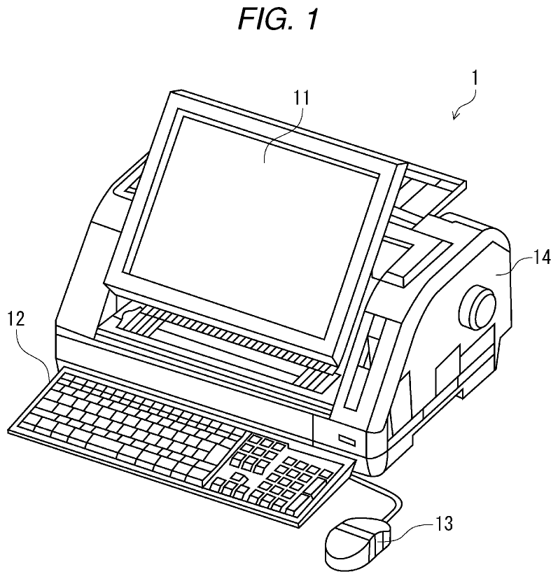

FIG. 1 is an exterior perspective view of an office computer 1.

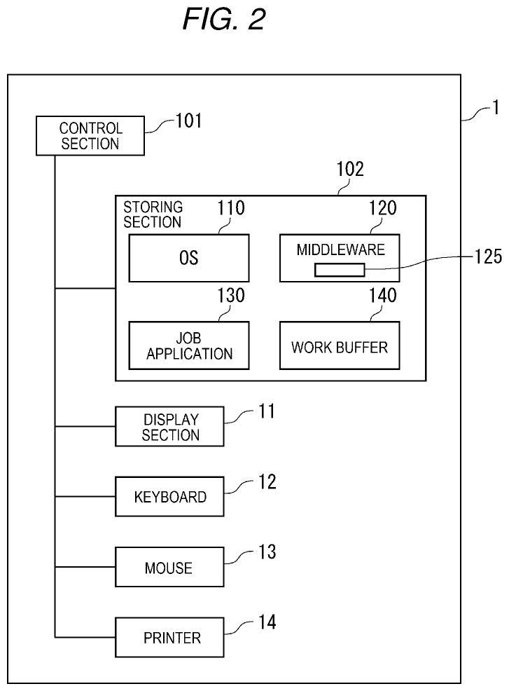

FIG. 2 is a functional block diagram illustrating a functional configuration of the office computer 1.

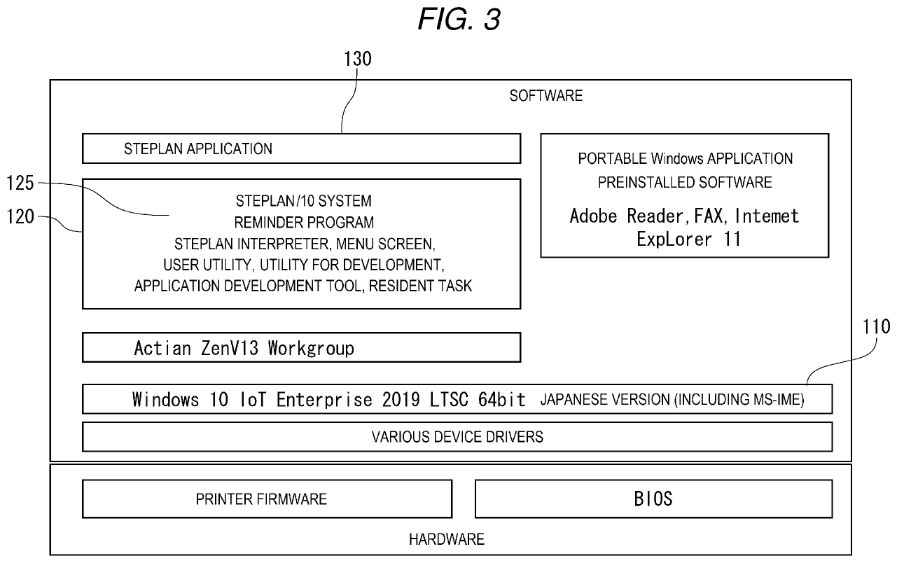

FIG. 3 is a software hierarchy chart of the office computer 1.

Office Computer

As illustrated in FIG. 1, the office computer 1 includes a printer 14 configured to form an image on a recording medium, a display section 11 such as a display integrally provided in the printer 14, and input devices such as a keyboard 12 and a mouse 13.

The printer 14 includes, on the front surface of the office computer 1 (the near side in FIG. 1), an insertion hole into which a recording medium is inserted and includes, on the rear surface of the display section 11 (the depth side of FIG. 1), a discharge port for discharging the recording medium.

The printer 14 includes an image forming section capable of performing printing copy slips. Examples of the image forming section include a dot matrix head.

The image forming section may be an electronic type such as a laser printer or may be an inkjet type. An operator inserts the recording medium from the insertion hole. In the case of an auto-feed mode, the office computer 1 sucks the inserted recording medium and supplies the recording medium to the printer 14.

As illustrated in FIG. 2, the office computer 1 includes a control section 101 including a CPU (central processing unit), which is an arithmetic device, a storing section 102 including a storage device such as a memory or a hard disk drive, an input and output section 103 including input and output devices such as the display section 11, the keyboard 12, and the mouse 13, and the printer 14.

The control section 101 (a deadline alert section or deadline alert means) collectively controls the office computer 1.

As illustrated in FIGS. 2 and 3, an operation system 110, middleware 120, job applications 130, a work buffer 140, and the like are stored in the storing section 102 (storing means).

The operation system 110 is a platform called operation system and is software for providing a common function necessary for operating the job applications 130. That is, the operation system 110 plays a role of mediating exchanges between hardware such as the keyboard 12 and the mouse 13 and the job applications 130 and surely controlling the operation of an entire system without waste.

The operation system 110 is specifically WINDOWS (registered trademark).

The middleware 120 is a type of a platform and is software positioned in the middle between the operation system 110 and the job applications 130. That is, the middleware 120 plays a role of mediating the operation system 110 and the job applications 130 and controlling the operation of the job applications 130.

The job applications 130 are software for performing specific jobs and are software for executing, in a computer, flows (job processes) of work of individual jobs. Examples of the job applications 130 include bill generation software and delivery statement generation software. The job applications 130 output deadline information of office work in respective jobs and cause the storing section 102 to store the deadline information.

The work buffer 140 is a storage region for work.

The middleware 120 and all the job applications 130 are created by STEPLAN (registered trademark), which is an original program language.

The storing section 102 stores a reminder program 125. The reminder program 125 is a part of the middleware 120 and is executed every time the office computer 1 starts.

The reminder program 125 is controlled by the middleware 120 and operates during a bootstrap started by power-on. That is, if the operator turns on the office computer 1, the operation system 110 starts. Subsequently, the control section 101 reads out the reminder program 125 from the storing section 102 and automatically executes the reminder program 125.

The reminder program 125 reads out deadline information created by the job applications 130 from the storing section 102. If there is a job close to a deadline, the reminder program 125 causes the display section 11 to display a reminder notification.

After confirming the reminder notification, the operator starts the job application 130. The control section 101 executes the job application 130 designated according to an instruction of the operator.

Reminder Notification: Software

Reminder processing (the reminder program 125) of the office computer 1 is explained.

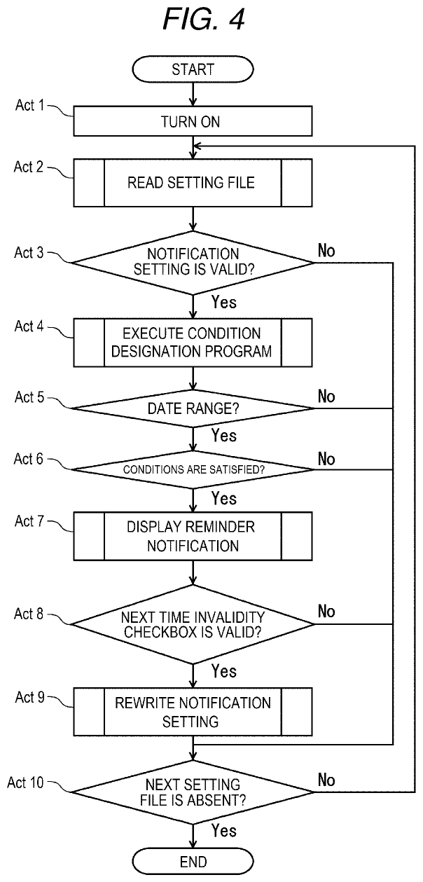

FIG. 4 is a flowchart illustrating a reminder processing process of the office computer 1.

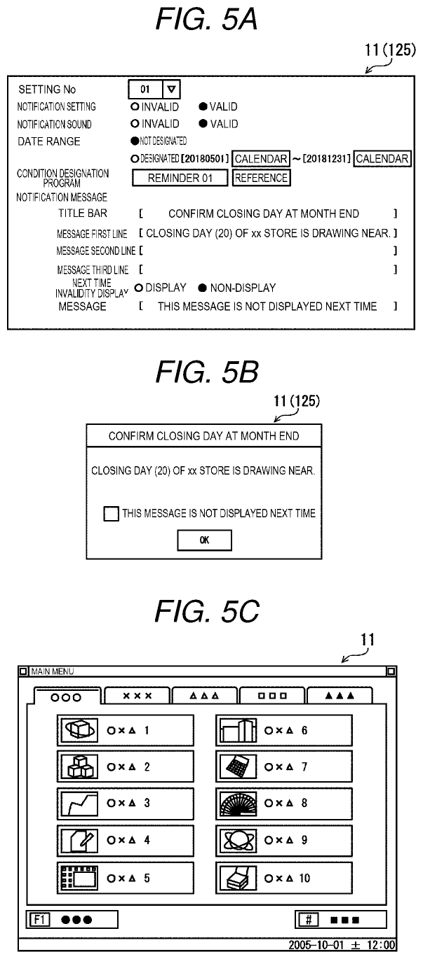

FIG. 5A is a diagram illustrating a setting screen for a reminder notification. FIG. 5B is a diagram illustrating the reminder notification. FIG. 5C is a diagram illustrating a home screen.

Prior to executing the reminder processing, the operator performs setting of a reminder notification.

Specifically, the operator selects and determines a plurality of setting matters on a reminder setting screen illustrated in FIG. 5A and creates a setting file.

In reminder setting, the operator selects and determines “setting No”, “notification setting”, “notification sound”, “date range”, “condition designation program”, “notification message”, and “next time invalidity display”.

The “setting No” determines priority order of reminder notifications. The reminder notifications are executed (displayed) in ascending order of the “setting No”. For example, if performing ten kinds of reminder setting, the operator can select and determine No. 1 to No. 10.

The “notification setting” performs validation and invalidation of a reminder notification. Only if the operator selects “valid” in the “notification setting”, the reminder program 125 is executed during the start of the office computer 1. That is, the reminder notification is displayed during the start.

The “notification sound” performs validation and invalidation of notification sound. Only if the operator selects “valid” in the “notification sound”, notification sound such as beep sound is sounded simultaneously with the display of the reminder notification.

The “date range” designates date and time when the reminder notification is displayed. If the operator selects “not designated” in the “date range”, all days are targets of the display of the reminder notification. That is, the reminder notification is performed every day. On the other hand, if the operator selects “designated”, the operator can select a start day and an end day from a calendar. The operator presses a calendar button to respectively select and determine the start day and the end day. Consequently, the reminder notification is performed between the start day and the end day.

The “condition designation program” selects a condition designation program describing a conditional statement for determining whether certain office work is a target of the reminder notification. For example, a customer name, an amount, date and time, work content, and the like are described in the condition designation program.

The “notification message” determines content desired to be displayed as a reminder message. Specifically, the operator inputs reminder messages in fields of a title bar and messages 1 to 3. Consequently, it is possible to display a reminder message corresponding to content, an emergency degree, and the like of office work.

The “next time invalidity display” enables the operator to select validation and invalidation of the reminder notification during the next start. If the operator selects “display” in the “next time invalidity display”, a checkbox is displayed in a reminder message. The operator can select invalidation of the reminder notification during the next start.

If the office computer 1 is turned on (Act 1) after the reminder setting is performed, the reminder program 125 is automatically started.

First, the reminder program 125 reads a setting file designated as No. 1 (Act 2).

Subsequently, the reminder program 125 determines whether the “notification setting” is valid or invalid (Act 3). If the notification setting is valid, the reminder program 125 proceeds to Act 4. On the other hand, if the notification setting is invalid, the reminder program 125 ends the setting file (reminder processing) designated as No. 1 and proceeds to Act 10.

In Act 4, the reminder program 125 reads a designated condition designation program.

Subsequently, the reminder program 125 determines whether the day is included in days designated in the “date range” (Act 5). If the day is included in the set days, the reminder program 125 proceeds to Act 6. On the other hand, if the day is not included in the set days, the reminder program 125 ends the setting file (the reminder processing) designated as No. 1 and proceeds to Act 10.

In Act 6, the control section 101 searches through the storing section 102 and determines presence or absence of deadline information of office work satisfying conditions described in the condition designation program. At this time, the control section 101 causes the display section 11 to flash a message “reminder being confirmed” during execution of the search and the determination of relevant data.

Subsequently, if deadline information satisfying the conditions is present, the control section 101 displays a reminder notification on the display section 11 (Act 7). At this time, the control section 101 selects and executes an image of the reminder notification and sounding of notification sound (beep sound) according to valid or invalid of the “notification sound” and valid (display) or invalid (non-display) of the “next time invalidity display” (see FIG. 5B).

On the other hand, if deadline information satisfying the conditions is absent, the control section 101 ends the setting file (the reminder processing) designated as No. 1 and proceeds to Act 10.

Subsequently, if the operator presses an “OK” button of the reminder notification, the control section 101 determines whether a checkbox of the next time invalidity is checked (Act 8).

If the checkbox of the next time invalidity is checked (valid), after ending the setting file (the reminder processing) designated as No. 1, the control section 101 switches the “notification setting” of the setting file to invalid (Act 9).

On the other hand, if the checkbox of the next time invalidity is not checked (invalid) or if the check box is not displayed, the control section 101 directly ends the setting file (the reminder processing) designated as No. 1.

Finally, the control section 101 determines whether a setting file designated as No. 2 or the subsequent setting number is present (Act 10).

If a setting file designated as No. 2 or the subsequent setting number is absent, the control section 101 ends the reminder processing. On the other hand, if a setting file designated as No. 2 or the subsequent setting number is present, the setting file is sequentially read. That is, Act 2 to Act 10 are repeated.

If all reminder settings (reminder notifications) are executed in this way, the reminder program 125 ends.

Then, the control section 101 causes the display section 11 to display a home screen (a menu screen) (see FIG. 5B). Consequently, the operator can start the job applications 130. That is, the operator can execute the job applications 130 and perform various kinds of office work.

As explained above, the office computer 1 in the embodiment includes the storing section 102 configured to store office work deadline information output from a plurality of job applications 130 for executing various kinds of office work and the control section 101 (the deadline alert section) configured to acquire deadline information from the storing section 102 and outputs a reminder notification. Since the reminder notification is delivered without the execution of the job applications 130, the operator can surely process the office work within a deadline.

Since the control section 101 outputs the reminder notification after acquiring the deadline information from the storing section 102, it is unnecessary to perform the reminder setting every time the deadline information stored in the storing section 102 is rewritten. Therefore, a necessary reminder notification is surely delivered.

The control section 101 executes (operates) the reminder program 125 during a bootstrap started by power-on. Therefore, the operator easily notices the reminder notification.

In particular, the reminder program 125 (the control section 101) displays the reminder notification prior to the home screen displayed after the start. Therefore, the operator easily notices the reminder notification.

Further, the reminder program 125 (the control section 101) is controlled by the middleware for mediating the job application 130 and the operation system 110. Therefore, it is possible to execute the reminder notification without starting the job application 130.

In the explanation in the embodiment, a plurality of reminder settings are present. However, not only this, but a plurality of reminder notifications may be output by one reminder setting.

In the explanation in the embodiment, the reminder notification is output based on the deadline information of the office work. However, not only this, but, for example, an alert notification may be output based on content (an amount, a work load, a frequency, and the like) of the office work.

The embodiments of the present disclosure are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. An office computer, comprising:
a memory that stores computer executable components and a processor that executes the computer executable components stored in the memory, wherein the computer executable components comprise:
a storing component configured to store office work deadline information output from a plurality of job applications for executing various kinds of office work; and
a deadline alert component configured to acquire the office work deadline information from the storing component and output a reminder notification without executing each of the job applications.

2. The office computer according to claim 1, wherein the deadline alert component operates during a bootstrap started by power-on.

3. The office computer according to claim 1, wherein the deadline alert component is controlled by middleware for mediating the job applications and an operation system.

4. The office computer according to claim 1, wherein the deadline alert component displays the reminder notification prior to displaying a home screen after a start.

5. The office computer according to claim 1, wherein the job applications comprise at least one of bill generation operations and delivery statement generation operations.

6. The office computer according to claim 1, further comprising:
a printer and a display.

7. The office computer according to claim 6, wherein the deadline alert component configured outputs the reminder notification to the display.

8. The office computer according to claim 1, wherein the reminder notification comprises a visual notification.

9. The office computer according to claim 1, wherein the reminder notification comprises an audio notification.

10. The office computer according to claim 1, wherein the deadline alert component is controlled by middleware not involved in executing the job applications.

11. A method, comprising:
storing office work deadline information output from a plurality of job applications for executing various kinds of office work in a memory; and
acquiring the office work deadline information from the memory and outputting a reminder notification without executing each of the job applications.

12. The method according to claim 11, wherein acquiring the office work deadline information is executed during a bootstrap started by power-on.

13. The method according to claim 11, wherein acquiring the office work deadline information is executed by middleware for mediating the job applications and an operation system.

14. The method according to claim 11, further comprising displaying the reminder notification prior to displaying a home screen after a start.

15. The method according to claim 11, wherein the job applications comprise at least one of bill generation operations and delivery statement generation operations.

16. The method according to claim 11, further comprising:
displaying information on a display.

17. The method according to claim 16, wherein outputting the reminder notification comprises outputting the reminder notification to the display.

18. The method according to claim 11, wherein outputting the reminder notification comprises outputting a visual notification.

19. The method according to claim 11, wherein outputting the reminder notification comprises outputting an audio notification.

20. The method according to claim 11, wherein outputting the reminder notification comprises controlling middleware not involved in executing the job applications.
